(19) United States
(12) Patent Application Publication
(10) Pub. No.: US 2005/0224568 A1
(43) Pub. Date: Oct. 13, 2005

(54) Rubbish bin

(76) Inventor: Duncan Bruce Waugh, Sydney (AU)

Correspondence Address: DUNCAN WAUGH, 5/68 Fletcher St, Bondi, 2026, AU

(21) Appl. No.: 11/126,877

(22) Filed: May 12, 2005

(30) Foreign Application Priority Data
Nov. 12, 2002 (AU) 2002313975

(51) Int. Cl. B65D 91/00; A47L 5/00; A47L 9/00; B60R 7/00

(52) U.S. Cl. 232/43.5; 224/280

(57) ABSTRACT

A rubbish bin (10) for use by passengers inside a motor vehicle includes a housing (12) defining an interior, a first opening (21) in the upper portion of the housing (12) through which rubbish may be inserted into the interior of the housing and a second opening (23) in the base through which the rubbish may be discharged from the housing. A removable cover (14) slidably is engaged with the base and adapted to be manually moved between a closed position in which the cover (14) closes the second opening and an open position in which the cover (14) is at least partially clear of the second opening to allow rubbish to be discharged from the interior of the housing (12).

### TECHNICAL FIELD

The present invention relates to a rubbish bin, and, in particular to a rubbish bin for use in a vehicle.

When driving or in using a motor vehicle many people find there is often an accumulation of rubbish within the vehicle. This may come from many sources including takeaway/drive through food packaging, confectionary wrappings or general rubbish accumulated in a vehicle when driving or travelling. For most people this rubbish is either placed on the floor, put in an unsightly plastic bag, stuffed into the ashtrays until a suitable receptacle is found when the journey is complete. In the worst cases the rubbish is thrown out the window.

### BACKGROUND ART

A rubbish bin suitable for use by passengers inside a motor vehicle is disclosed in Australian Petty Patent No. 733,762 which has a housing having a first opening through which rubbish may be inserted into the housing and a removable end through which the rubbish may be discharged from the housing when the housing is held in an inverted position. A disadvantage of this rubbish bin of the prior art is that the discharge opening is smaller than the first opening and this leads to some difficulty in emptying the rubbish bin.

### DISCLOSURE OF THE INVENTION

The abovementioned problems can be overcome by the present invention, which provides a rubbish bin which can be placed on the floor of the motor vehicle directly in front of any of the passengers seats to allow the easy and accessible collection of rubbish in the vehicle, and then the simple disposal of this waste from the rubbish bin to a larger waste receptacle separate from the vehicle, for example, a roadside or domestic rubbish bin.

According to one aspect of the invention there is provided a rubbish bin suitable for use by passengers inside a motor vehicle, said rubbish bin comprising:—
(i) a housing having an upper portion, first and second ends and a base, the housing defining an interior,
(ii) a first opening in the upper portion of the housing through which rubbish may be inserted into the interior of the housing,
(iii) a second opening in the base through which the rubbish may be discharged from the housing, and
(iv) a removable cover slidably engaged with the base and adapted to be manually moved between a closed position in which the cover closes the second opening and an open position in which the cover is at least partially clear of the second opening to allow rubbish to be discharged from the interior of the housing.

### BRIEF DESCRIPTION OF THE DRAWINGS

FIG. 1 is a perspective view of a rubbish bin according to an embodiment of the invention with the lid partially open;

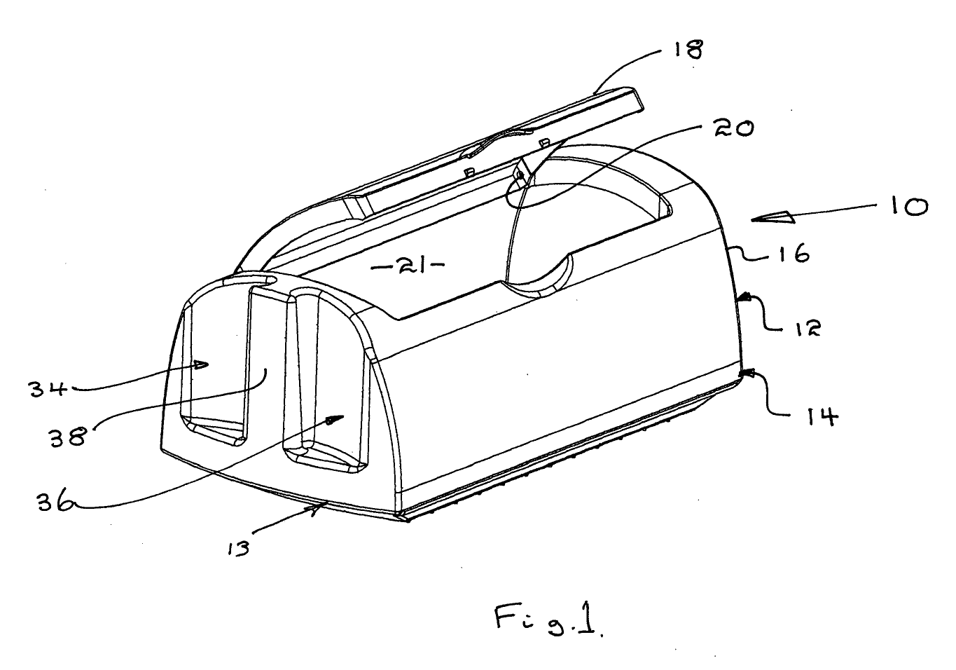

FIG. 2 is a perspective view of the rubbish bin shown in FIG. 1 with the lid closed;

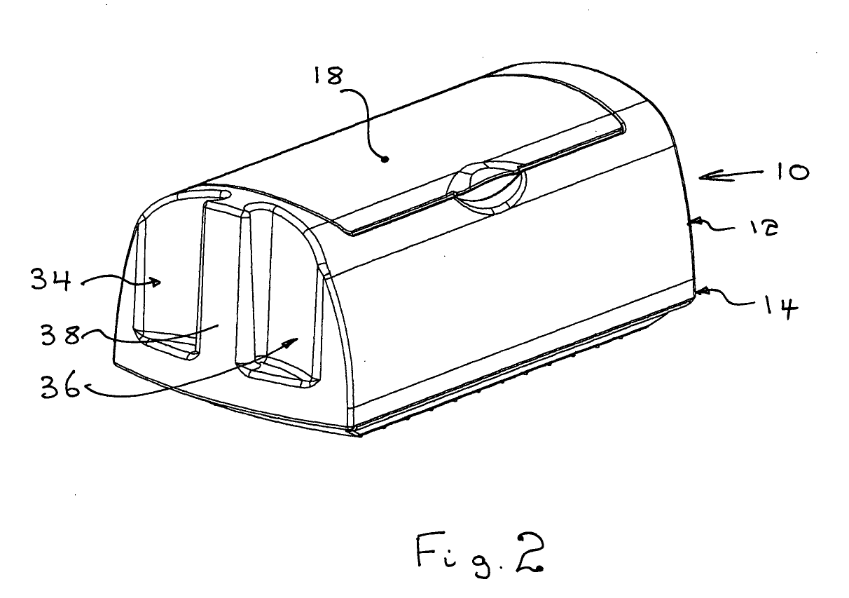

FIG. 3 is a perspective view from below of the rubbish bin shown in FIGS. 1 and 2 with the cover member open and;

FIG. 4 is another perspective view from below of the rubbish bin shown in FIGS. 1 and 2 with the cover member open.

### BEST MODE FOR CARRYING OUT THE INVENTION

Referring to the drawings, there is shown a rubbish bin 10 which includes a housing 12 having a base 13 and a cover 14. The housing 12 and the cover 14 may be formed of any suitable material which is sufficiently strong and non-brittle, such as a plastics material.

The housing portion 12 is of generally elongate shape and includes an upper portion 16 and a lid 18 hingedly mounted to the upper portion 16 at hinges 20. The upper portion 16 defines a first opening 21 coverable by the lid 18 and a second opening 23 in its base coverable by the cover 14.

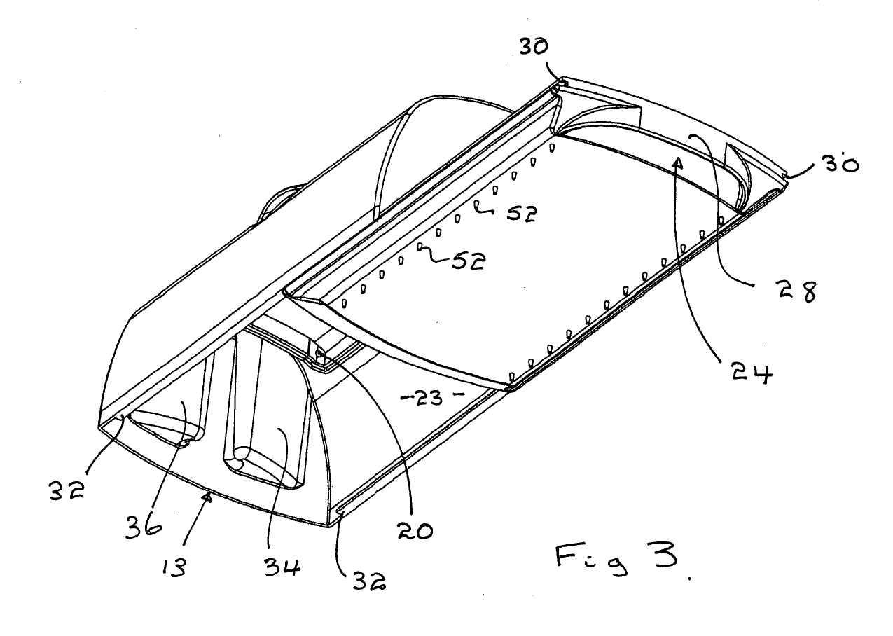

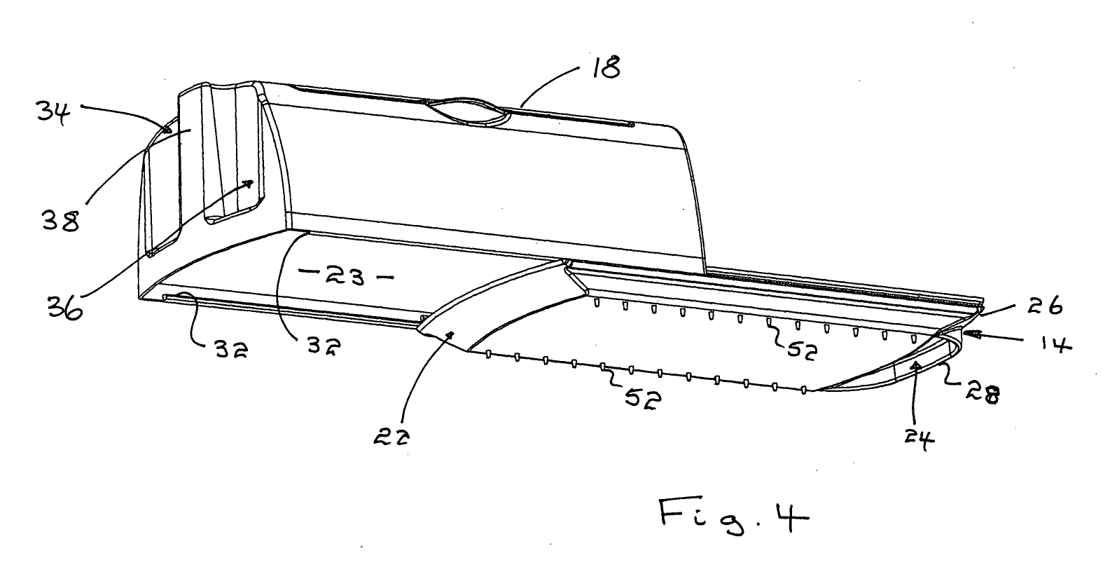

The upper portion 16 also includes a first and second vertical recess 34 and 36 which form a grip member 38 which together form a first handle. The arrangement is such that a user is able to grip the first grip member 38 and thereby firmly hold the housing portion 12 to assist with the disposal of rubbish from the housing portion 12 when the cover portion 14 is open as shown in FIGS. 3 and 4.

The cover 14 is of a generally rectangular shape and includes a wall 28 which provides a grip portion 24 or second handle which is arranged so that a user is able to grip the second grip member 24 and thereby firmly hold the cover 14 to engage or disengage the cover 14 from the upper portion 16 whilst holding the first grip member 38.

The cover 14 also includes a groove 30 running longitudinally along each longitudinal sides of the cover 14. These grooves 30 correspond with lips 32 running longitudinally along the edges of the base of the upper portion 16. This arrangement allows the user to engage the cover 14 with the upper portion 16 by sliding the cover 14 along the underside of the upper portion 16 to close the cover 14, in this way the second opening 23 is covered by the cover 14 to prevent rubbish from passing through the second opening 23.

Similarly the user is able to disengage the cover 14 from the upper portion 16 by pulling and thus sliding the cover 14 away from the body portion with a leading end 22 and a trailing end 26 to allow rubbish to pass through the second opening 23 when disposing of rubbish.

The cover 14 also includes a fixing means 52 which serves to removably fix the rubbish bin 10 to a surface such as a floor of a vehicle when the cover 14 is closed. The fixing means may be a plurality of spikes 52 projecting downwardly from the outer surface of the cover member 14. In another embodiment, Velcro strip(s) may be adhesively fixed to an underside surface of the cover member 14 so that the rubbish bin is removably fixable to, for example, a floor of a vehicle. Of course where the floor to the vehicle to which the rubbish bin 10 is to be fixed is not provided with carpet or similar material, a corresponding Velcro portion would be adhesively fixed to the floor of the vehicle.

In use, the rubbish bin typically locates on the floor of a vehicle. In order to place rubbish in the rubbish bin 10, a user lifts the lid 18 and passes the rubbish through the first aperture 21 and into the housing portion 12. After the user had disposed the rubbish in the housing portion 12, the lid 18 is closed to cover the first aperture 21 and prevent egress of rubbish from the housing portion 12.

When it is desired to empty the rubbish bin 10, for example, when the rubbish bin 10 has become full, the user positions the rubbish bin 10 over, or in a suitable receptacle such as a large garbage bag/bin, the user grips the first grip member 38, then grips the second grip member 26, by using the second grip member 26, the user then pulls the cover member 14 so that it slides along the bottom of the body portion 16 until the second aperture 23 is sufficiently large enough to allow the rubbish to pass through the second aperture.

It will be appreciated that although the cover member 14 of the above embodiment is completely separable from the housing portion 12 it is not always necessary to completely separate the cover member 14 from the housing portion 12 when emptying the rubbish from the rubbish bin 10.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A rubbish bin suitable for use by passengers inside a motor vehicle, said rubbish bin comprising:—
(i) a housing having an upper portion, first and second ends and a base, the housing defining an interior,
(ii) a first opening in the upper portion of the housing through which rubbish may be inserted into the interior of the housing,
(iii) a second opening in the base through which the rubbish may be discharged from the housing, and
(iv) a removable cover slidably engaged with the base and adapted to be manually moved between a closed position in which the cover closes the second opening and an open position in which the cover is at least partially clear of the second opening to allow rubbish to be discharged from the interior of the housing.

2. A rubbish bin according to claim 1 wherein the first end of the housing has a handle disposed on its outside.

3. A rubbish bin according to claim 1 wherein the removable cover has a leading end and a trailing end, the trailing end having a handle disposed on its outside.

4. A rubbish bin according to claim 1 where the exterior of the removable cover has fastening means for removably affixing the rubbish bin to a surface in a vehicle.

5. A rubbish bin according to claim 4 wherein the fastening means comprises spikes projecting downwardly from the outer surface of the cover.

6. A rubbish bin according to claim 1 and further including a lid adapted to removably close the first opening.

7. A rubbish bin according to claim 1 wherein the periphery of the base of the housing has lips which are received in grooves running longitudinally along both sides of the cover.
